(19) United States
(12) Patent Application Publication
(10) Pub. No.: US 2023/0152468 A1
(43) Pub. Date: May 18, 2023

(54) RANGING DEVICE

(71) Applicant: DENSO CORPORATION, Kariya-city (JP)

(72) Inventors: Takayoshi FUJISAWA, Kariya-city (JP); Fumiaki MIZUNO, Kariya-city (JP)

(21) Appl. No.: 18/156,289

(22) Filed: Jan. 18, 2023

Related U.S. Application Data
(63) Continuation of application No. PCT/JP2021/026134, filed on Jul. 12, 2021.

(30) Foreign Application Priority Data
Jul. 22, 2020 (JP) 2020-125659

(51) Int. Cl. G01S 17/931; G01S 7/481

(52) U.S. Cl. CPC G01S 17/931; G01S 7/4817; G01S 7/4815

(57) ABSTRACT

A ranging device includes a plurality of ranging units and a control unit configured to control the plurality of ranging units. Each of the ranging units includes a deflection member configured to deflect laser light and performs ranging processing that scans a predetermined ranging area with emitted laser light by rotating or oscillating the deflection member to change the emission azimuth of the laser light, and measures a distance to an object located in the emission azimuth based on reflected light received from the same azimuth as the emission azimuth. The plurality of ranging units include a first ranging unit and a second ranging unit with the ranging areas overlapping with each other. The control unit causes the first ranging unit to perform the ranging processing and the second ranging unit to perform ranging processing in parallel with each other in a manner to prevent the area traveled by laser light emitted by the first ranging unit and the area traveled by laser light emitted by the second ranging unit from interfering with each other in the ranging areas.

### CROSS-REFERENCE TO RELATED APPLICATION

This application is the U.S. bypass application of International Application No. PCT/JP2021/026134 filed on Jul. 12, 2021 which designated the U.S. and claims priority to Japanese Patent Application No. 2020-125659 filed on Jul. 22, 2020, the contents of both of which are incorporated herein by reference.

### TECHNICAL FIELD

The present disclosure relates to a ranging device.

### BACKGROUND

LIDAR devices are known that measure distances to objects based on reflected light of laser light. A LIDAR device performs ranging processing that scans a predetermined ranging area with emitted laser light by rotating or oscillating a deflection member to change the emission azimuth of the laser light, and measures a distance to an object located in the emission azimuth based on reflected light received from the same azimuth as the emission azimuth.

### SUMMARY

An aspect of the present disclosure is a ranging device including a plurality of ranging units and a control unit. The control unit is configured to control the ranging units. Each of the ranging units includes a deflection member that deflects laser light and is configured to perform ranging processing that scans a predetermined ranging area with emitted laser light by rotating or oscillating the deflection member to change the emission azimuth of the laser light, and measures a distance to an object located in the emission azimuth based on reflected light received from the same azimuth as the emission azimuth. The plurality of ranging units include a first ranging unit and a second ranging unit with the ranging areas overlapping with each other. The control unit causes the first ranging unit to perform the ranging processing and the second ranging unit to perform ranging processing in parallel with each other in a manner to prevent a first passage area traveled by laser light emitted by the first ranging unit and a second passage area traveled by laser light emitted by the second ranging unit from interfering with each other in the ranging areas.

### BRIEF DESCRIPTION OF THE DRAWINGS

The above features of the present disclosure will be made clearer by the following detailed description, given referring to the appended drawings. In the accompanying drawings:

FIG. 1 is a diagram showing the arrangement of ranging units on a vehicle;

FIG. 2 is a block diagram showing the configuration of a ranging device;

FIG. 3 is a schematic perspective view showing the configuration of a ranging unit;

FIG. 4 is a diagram showing periodic changes in the rotation angle of a deflection member;

FIG. 5 is a diagram showing rotational movement directions of the deflection member;

FIG. 6 is a diagram showing a state in which the passage areas of laser light emitted from a plurality of ranging units interfere with each other within ranging areas;

FIG. 7 is a diagram showing a state with the boundary surface of an object being within the area in which the passage areas of laser light emitted from the ranging units interfere with each other;

FIG. 8 is a diagram showing a state in which one ranging unit has received reflected light of laser light emitted from another ranging unit;

FIG. 9 is a diagram showing the ranging areas of two ranging units;

FIG. 10 is a diagram showing conditions concerning the timing of start according to the positional relationship of two ranging units;

FIG. 11 is a diagram showing the positional relationship of ranging units in a first arrangement example;

FIG. 12 is a diagram showing changes in the rotation angles of the deflection members of the ranging units in the first arrangement example;

FIG. 13 is a diagram showing changes in the rotation angles of the deflection members of the ranging units in another example of the first arrangement example;

FIG. 14 is a diagram showing the positional relationship of ranging units in a second arrangement example;

FIG. 15 is a diagram showing changes in the rotation angles of the deflection members of the ranging units in the second arrangement example;

FIG. 16 is a diagram showing the positional relationship of ranging units in a third arrangement example;

FIG. 17 is a diagram showing changes in the rotation angles of the deflection members of the ranging units in the third arrangement example;

FIG. 18 is a diagram showing the positional relationship of ranging units in another example of the third arrangement example;

FIG. 19 is a diagram showing changes in the rotation angles of the deflection members of the ranging units in the other example of the third arrangement example;

FIG. 20 is a diagram showing the positional relationship of ranging units in a fourth arrangement example;

FIG. 21 is a diagram showing changes in the rotation angles of the deflection members of the ranging units in the fourth arrangement example;

FIG. 22 is a diagram showing the positional relationship of ranging units in another example of the fourth arrangement example;

FIG. 23 is a diagram showing changes in the rotation angles of the deflection members of the ranging units in the other example of the fourth arrangement example;

FIG. 24 is a diagram showing the positional relationship of ranging units in a fifth arrangement example;

FIG. 25 is a diagram showing changes in the rotation angles of the deflection members of the ranging units in the fifth arrangement example;

FIG. 26 is a diagram showing the positional relationship of ranging units in a sixth arrangement example;

FIG. 27 is a diagram showing changes in the rotation angles of the deflection members of the ranging units in the sixth arrangement example;

FIG. 28 is a diagram showing the positional relationship of ranging units in another example of the sixth arrangement example;

FIG. 29 is a diagram showing changes in the rotation angles of the deflection members of the ranging units in the other example of the sixth arrangement example;

FIG. 30 is a diagram showing changes in current in the case where a plurality of ranging units scan synchronously;

FIG. 31 is a diagram showing changes in current in the case where a plurality of ranging units scan asynchronously;

FIG. 32 is a diagram showing changes in the rotation angles of the deflection members of ranging units according to a second embodiment;

FIG. 33 is a diagram showing ranging units aligned with the rotation axis of the deflection members;

FIG. 34 is a diagram showing changes in the rotation angles of the deflection members of ranging units with sinusoidal waveforms;

FIG. 35 is a diagram showing changes in the rotation angles of the deflection members of ranging units with waveforms different from each other; and

FIG. 36 is a diagram showing changes in the rotation angles of the deflection members of ranging units with aperiodic rotational movements.

### DETAILED DESCRIPTION OF THE PREFERRED EMBODIMENTS

US2019/0011544 A describes a technique that uses a LIDAR device mounted on a vehicle to measure a distance to an object in the environment surrounding the vehicle.

When multiple ranging units that perform ranging processing are arranged in such a way that their ranging areas overlap each other, every object in a wide area may be detected.

However, detailed research carried out by the present inventors has revealed that when laser light emitted from one of the multiple ranging units is reflected by an object in an overlapping ranging area and received by another ranging unit, the distance to the object may be measured erroneously.

One aspect of the present disclosure provides a technique that prevents a plurality of ranging units having overlapping ranging areas from erroneously measuring a distance to an object.

An aspect of the present disclosure is a ranging device including a plurality of ranging units and a control unit. The control unit is configured to control the ranging units. Each of the ranging units includes a deflection member that deflects laser light and is configured to perform ranging processing that scans a predetermined ranging area with emitted laser light by rotating or oscillating the deflection member to change the emission azimuth of the laser light, and measures a distance to an object located in the emission azimuth based on reflected light received from the same azimuth as the emission azimuth. The plurality of ranging units include a first ranging unit and a second ranging unit with the ranging areas overlapping with each other. The control unit causes the first ranging unit to perform the ranging processing and the second ranging unit to perform ranging processing in parallel with each other in a manner to prevent a first passage area traveled by laser light emitted by the first ranging unit and a second passage area traveled by laser light emitted by the second ranging unit from interfering with each other in the ranging areas.

The technique according to the aspect can prevent a plurality of ranging units having overlapping ranging areas from erroneously measuring a distance to an object.

Exemplary embodiments of the present disclosure will now be described with reference to the drawings.

### 1. First Embodiment

### [1-1. Whole Configuration]

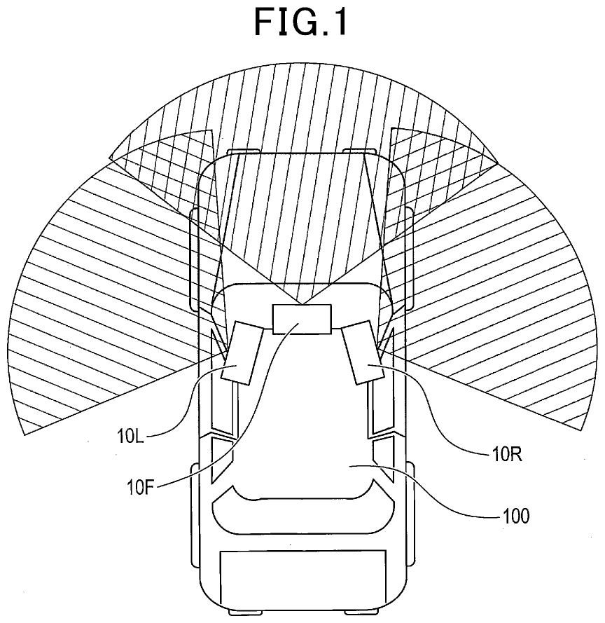

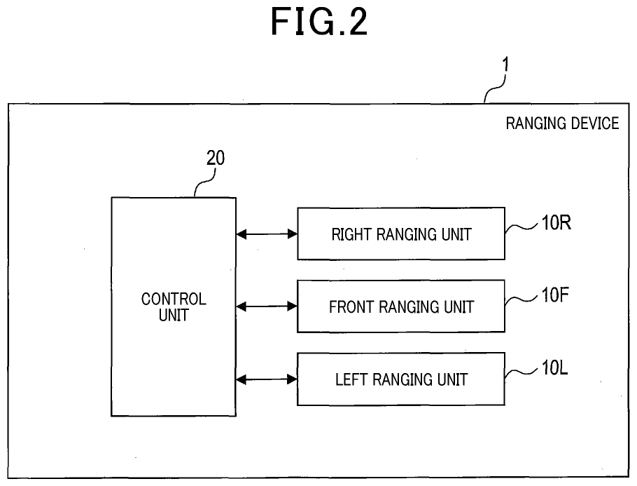

As shown in FIGS. 1 and 2, a ranging device 1 according to the present embodiment is mounted on a vehicle 100. The ranging device 1 is a device that measures a distance to a forward object in the environment surrounding the vehicle 100. The ranging device 1 includes a control unit 20 and three ranging units, or specifically, a right ranging unit 10R, a front ranging unit 10F, and a left ranging unit 10L.

Each of the right ranging unit 10R, the front ranging unit 10F, and the left ranging unit 10L is configured to perform ranging processing. The ranging processing is processing that scans a predetermined ranging area with emitted laser light by rotating or oscillating a deflection member 13 described later to change the emission azimuth of the laser light, and measures a distance to an object located in the emission azimuth based on reflected light received from the same azimuth as the emission azimuth.

The ranging area is an object detection range defined in design. The ranging area is determined by, for example, an angular range scanned with laser light during a ranging period and the longest distance that allows object detection.

The right ranging unit 10R is designed to scan a forward ranging area on the right of the vehicle 100 with laser light. The front ranging unit 10F is designed to scan a forward ranging area in front of the vehicle 100 with laser light. The left ranging unit 10L is designed to scan a forward ranging area on the left of the vehicle 100 with laser light. Each ranging unit is arranged in such a way that the ranging area overlaps with the ranging area of the adjacent ranging unit. In the present embodiment, the right ranging unit 10R and the left ranging unit 10L are arranged with their ranging areas overlapping with the ranging area of the front ranging unit 10F. [1-2. Configuration of Ranging Unit]

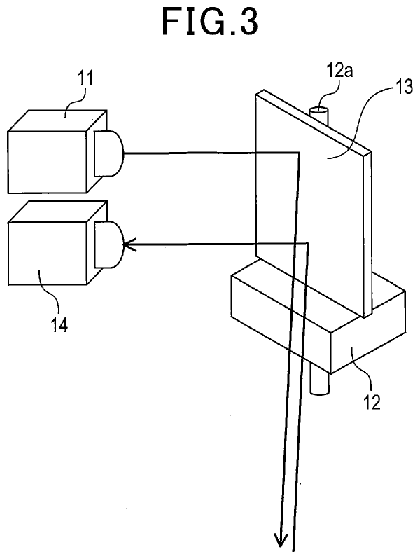

The right ranging unit 10R, the front ranging unit 10F, and the left ranging unit 10L have the same basic configuration. The configuration of each ranging unit will now be described with reference to FIG. 3.

Each ranging unit includes a projector 11, a drive 12, the deflection member 13, and a light receiver 14.

The projector 11 is a light source that emits laser light. The laser light in the present embodiment is pulsed laser light. The projector 11 is designed to emit laser light to the deflection member 13 in accordance with an instruction from the control unit 20.

The drive 12 is an actuator that rotates or swings the deflection member 13. The drive 12 includes a rod-shaped shaft 12a and rotates or swings the shaft 12a. In the present embodiment, the drive 12 is a motor that swings the shaft 12a. The rotation timing, the rotational movement direction, and the angular velocity of the shaft 12a are controlled by the control unit 20.

The deflection member 13 is a deflector that deflects laser light. In the present embodiment, the deflection member 13 is a mirror. The deflection member 13 is fixed to the shaft 12a of the drive 12 and swings together with the shaft 12a. When the deflection member 13 swings, laser light emitted from the projector 11 is deflected by the deflection member 13 depending on its rotation angle, and the ranging area is scanned. The scanning laser light is reflected by an object in the ranging area, and the reflected light is deflected by the deflection member 13 depending on its rotation angle and received by the light receiver 14.

The light receiver 14 is a sensor that receives laser light. The light receiver 14 is installed at a position on which the reflected light is incident. The reflected light comes from the same azimuth as the emission azimuth of the scanning laser light directed by the deflection member 13, and is deflected by the deflection member 13 and received. The light receiver 14 converts the received laser light into an electrical signal and outputs the signal to the control unit 20.

### [1-3. Configuration of Control Unit]

The control unit 20 shown in FIG. 2 is an electronic controller that is mainly a well-known microcomputer including a CPU, a ROM, and a RAM (not shown). The CPU executes programs stored in the ROM, which is a non-transitory tangible recording medium. The execution of the programs implements the methods corresponding to the programs. The control unit 20 may include a single microcomputer or multiple microcomputers. The functions of the control unit 20 may not be implemented by software. Some or all of the functions may be implemented by one or more pieces of hardware. For example, for the functions implemented by an electronic circuit, which is a piece of hardware, the electronic circuit may be a digital circuit, an analog circuit, or a combination of these circuits.

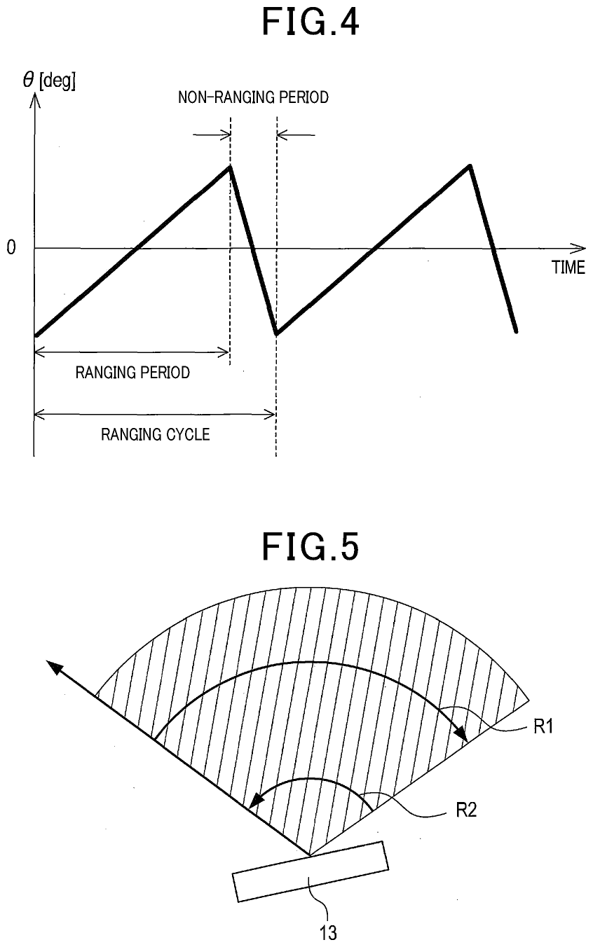

The control unit 20 controls the right ranging unit 10R, the front ranging unit 10F, and the left ranging unit 10L and measures a distance to an object in the environment surrounding the vehicle 100. In FIG. 4, the horizontal axis represents time, and the vertical axis represents the rotation angle of the deflection member 13, with the middle of the swing angular range of the deflection member 13 defined as 0. The cycle in which the deflection member 13 swings is the cycle in which each ranging unit performs distance measurement. Hereinafter, the cycle in which distance measurement is performed is also referred to as the ranging cycle. In the ranging cycle, the period during which distance measurement is performed is also referred to as the ranging period, and the period during which no distance measurement is performed is also referred to as the non-ranging period. In the present embodiment, to increase the proportion of the ranging period in the ranging cycle, the ranging unit is controlled in such a way that the angular velocity of the deflection member 13 during the non-ranging period is higher than the angular velocity of the deflection member 13 during the ranging period. The angular velocity of the deflection member 13 during the ranging period is also referred to as the ranging angular velocity. In FIG. 5, the deflection member 13 during the ranging period has a rotational movement direction R1, and the deflection member 13 during the non-ranging period has a rotational movement direction R2, with these directions indicated by arrows. In the example in FIG. 5, the ranging unit scans with laser light in a direction from left to right in FIG. 5. In the present embodiment, for the sake of simplicity, the whole period during which the deflection member 13 rotates in the rotational movement direction R1 is considered as the ranging period. Hereinafter, the direction in which the ranging unit scans with laser light is also referred to as the scanning direction.

In the present embodiment, the control unit 20 causes each ranging unit to perform ranging processing in the same scanning direction, in the same ranging cycle, and with the same ranging angular velocity. That is, each ranging unit performs ranging processing by cyclically scanning with laser light in a specific direction at a predetermined angular velocity. Specifically, the deflection member 13 swings in certain cycles, and during the period when the deflection member 13 moves in the specific direction in a rotational manner, the projector 11 emits laser light to the deflection member 13. In other words, during the period when the deflection member 13 moves in a direction opposite the specific direction in a rotational manner, the projector 11 emits no laser light to the deflection member 13.

### [1-4. Mechanism for Preventing Erroneous Measurement Caused by Overlapping Ranging Areas]

As described above, the ranging units are arranged with their ranging areas overlapping with one another. This arrangement is intended to eliminate blind spots and enable every object to be detected. However, when laser light emitted by one of the ranging units is reflected by an object in the part of the ranging area overlapping with the ranging area of another ranging unit, the arrangement may cause erroneous measurement of the distance to the object.

The present inventors have found that the satisfaction of the following three conditions causes erroneous measurement.

First condition: as illustrated in FIG. 1, the ranging areas of a plurality of ranging units at least partly overlap with each other.

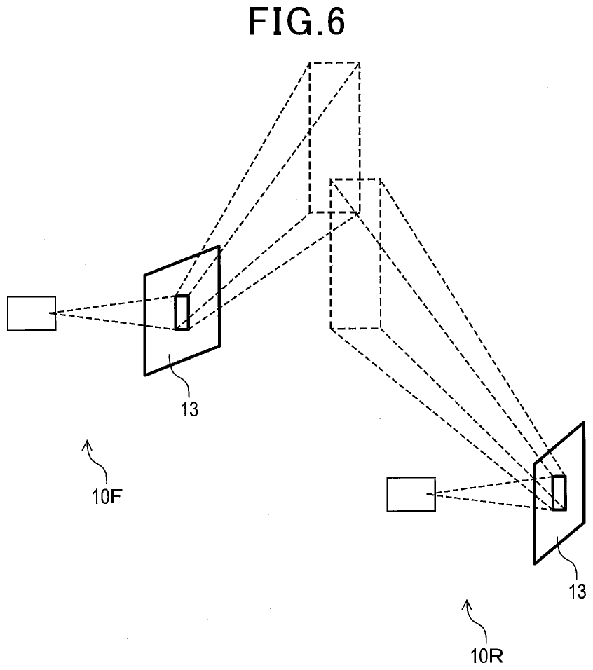

Second condition: the passage areas of laser light emitted from a plurality of ranging units interfere with each other within the ranging areas. In the example shown in FIG. 6, the passage area of laser light emitted from the right ranging unit 10R interferes with the passage area of laser light emitted from the front ranging unit 10F within the ranging areas (not shown).

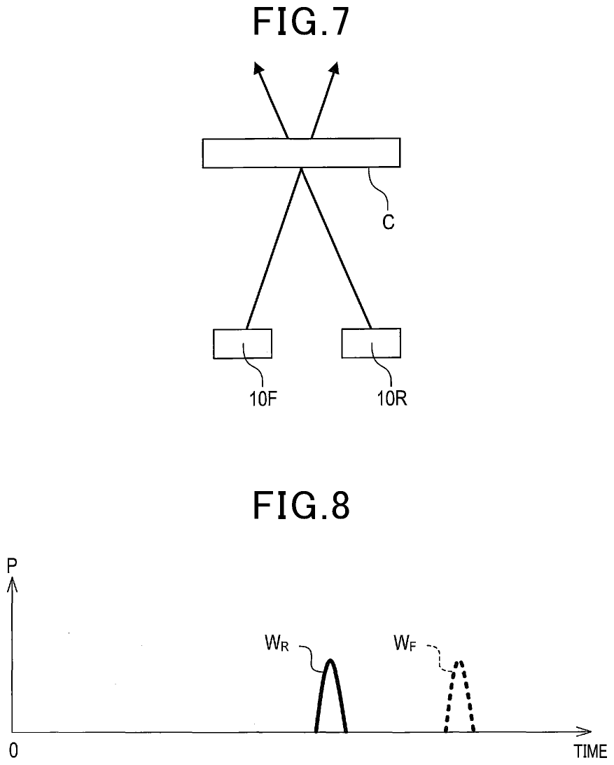

Third condition: an object boundary surface is within the area of interference between the passage areas of emitted laser light. In the example shown in FIG. 7, an object boundary surface C is within the area of interference between the passage area of laser light emitted from the right ranging unit 10R and the passage area of laser light emitted from the front ranging unit 10F. In FIG. 7, the laser light passage areas are indicated by lines for the sake of simplicity.

The passage area of laser light emitted by a ranging unit is an area extending along the emission azimuth of the laser light, and emitted laser light passes through the area. That is, the passage area of laser light emitted by a ranging unit is an area having the same width of the laser light. For example, when emitted light is pulsed laser light, the area is determined during not only the ON period of pulse wave but also the OFF period.

With the above three conditions combined, when laser light emitted by one of the ranging units is reflected by an object in the part of the ranging area overlapping with the ranging area of another ranging unit, the other ranging unit may receive the reflected laser light. For example, FIG. 8 shows the waveform of laser light received by the front ranging unit 10F. In FIG. 8, the horizontal axis represents time, with the point in time of laser light emission by the front ranging unit 10F defined as 0, and the vertical axis represents the intensity of received light. In this example, the reflected light of laser light emitted by the right ranging unit 10R is received by the front ranging unit 10F earlier. Thus, a waveform W_{F} of the reflected light of laser light emitted by the front ranging unit 10F is detected after a waveform W_{R} of the reflected light of laser light emitted by the right ranging unit 10R. The distance to an object is measured by the difference between the time of laser light emission and the time of reflected light reception, and thus the front ranging unit 10F in this case will erroneously measure the distance to the object.

Among the above three conditions, the first condition is nearly inevitable because of the design. In addition, the third condition is due to an external cause and cannot be controlled. Thus, in the ranging device 1 according to the present embodiment, the control unit 20 controls each ranging unit in a manner to prevent the second condition from being satisfied. Specifically, the control unit 20 controls the start timing of laser light scanning by each ranging unit in a manner to prevent the passage areas of laser light emitted by the multiple ranging units from interfering with each other within the ranging areas. Conditions for the start timing vary depending on the positional relationship of the ranging units.

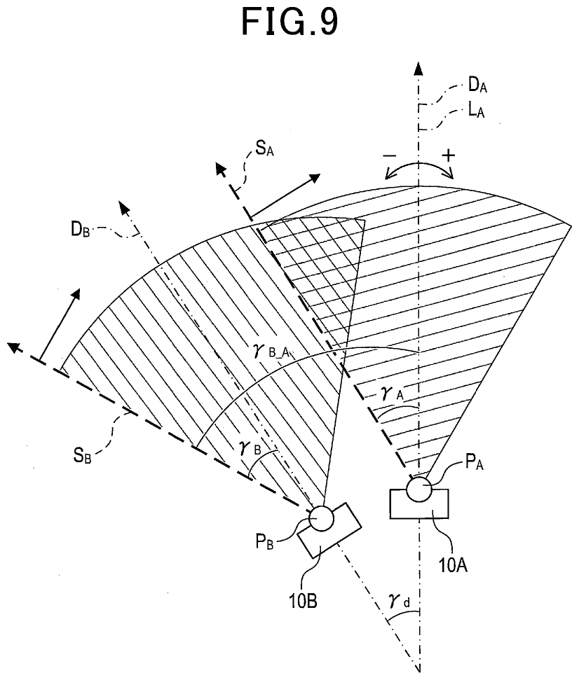

The conditions for the start timing depending on the positional relationship of two ranging units will now be described. FIG. 9 shows any two of the three ranging units mounted on the vehicle 100 as a ranging unit 10A and a ranging unit 10B arranged with their ranging areas overlapping with each other. The signs used in FIG. 9 have the meanings listed below, and the positions and the angles are determined as viewed from above in a direction along the rotation axis of the deflection member 13 included in the ranging unit 10A or the ranging unit 10B. In the present embodiment, the rotation axes of the deflection members 13 included in the ranging unit 10A and the ranging unit 10B are parallel with each other. However, the rotation axes may not be parallel but may be, for example, nearly parallel.

D_{A} . . . Reference azimuth of ranging unit 10A

D_{B} . . . Reference azimuth of ranging unit 10B

S_{A} . . . Starting azimuth of laser light scan by ranging unit 10A

S_{B} . . . Starting azimuth of laser light scan by ranging unit 10B

P_{A} . . . Origin position and point of laser light deflection on deflection member 13 of ranging unit 10A

P_{B} . . . Origin position and point of laser light deflection on deflection member 13 of ranging unit 10B

L_{A} . . . Line passing through origin position P_{A} and parallel with reference azimuth D_{A}

γ_{A} . . . Starting angle, or angle of starting azimuth S_{A} relative to reference azimuth D_{A} defined as 0

γ_{B} . . . Starting angle, or angle of starting azimuth S_{B} relative to reference azimuth D_{B} defined as 0

γ_{d} . . . . Shifted position angle, or angle of reference azimuth D_{B} relative to reference azimuth D_{A} defined as 0

γ_{B_A} . . . Opening angle, or angle of starting azimuth S_{B} relative to reference azimuth D_{A} defined as 0

The reference azimuth of a ranging unit is an azimuth defined as a reference in design. For example, with a laser light transmissive window installed, the reference azimuth is typically the forward direction of the transmissive window, or specifically, the direction normal to the center or an area surrounding the center of the surface of the transmissive window. In the present embodiment, the reference azimuth coincides with the azimuth of the center of the angular range for laser light scanning during the ranging period.

The values of the starting angles γ_{A} and γ_{B}, the shifted position angle γ_{d}, and the opening angle γ_{B_A} increase as the respective azimuths turn in the scanning direction of the ranging unit 10A. The starting angles γ_{A} and γ_{B}, the shifted position angle γ_{d}, and the opening angle γ_{B_A} each take positive values in the scanning direction with respect to the corresponding reference azimuth and negative values in the direction opposite the scanning direction.

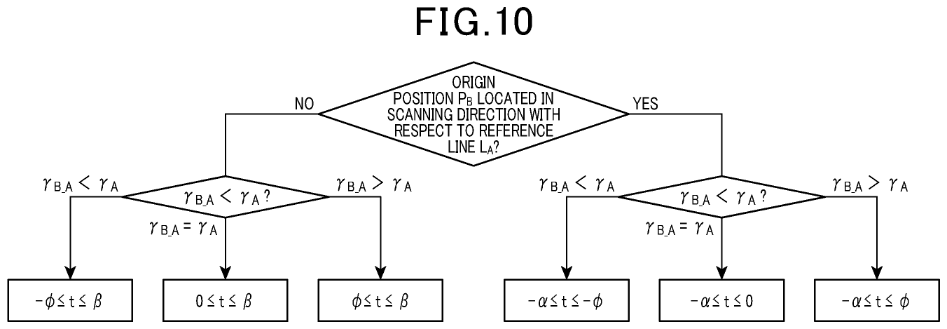

As shown in FIG. 10, the conditions for the start timing are classified into six conditions in accordance with the positional relationship of the ranging unit 10A and the ranging unit 10B. The six conditions will now be described based on six examples of arrangement.

### (First Arrangement Example)

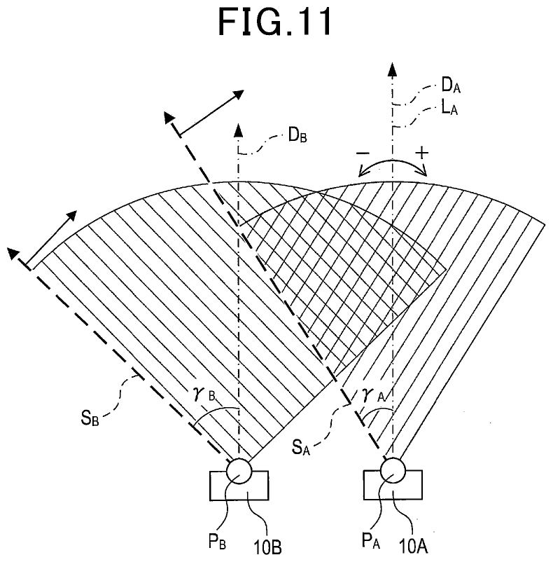

As shown in FIG. 11, a first arrangement example is an example in which the ranging unit 10A and the ranging unit 10B are arranged in such a way that the origin position P_{B} is placed in the direction opposite the scanning direction of the ranging unit 10A with respect to the reference line L_{A}, and the starting angle γ_{A} and the opening angle γ_{B_A} satisfy the relation of γ_{B_A}<γ_{A}. In the first arrangement example shown in FIG. 11, the ranging unit 10A and the ranging unit 10B are arranged with the reference azimuth D_{A} and the reference azimuth D_{B} parallel to each other. However, this is not a condition for the first arrangement example.

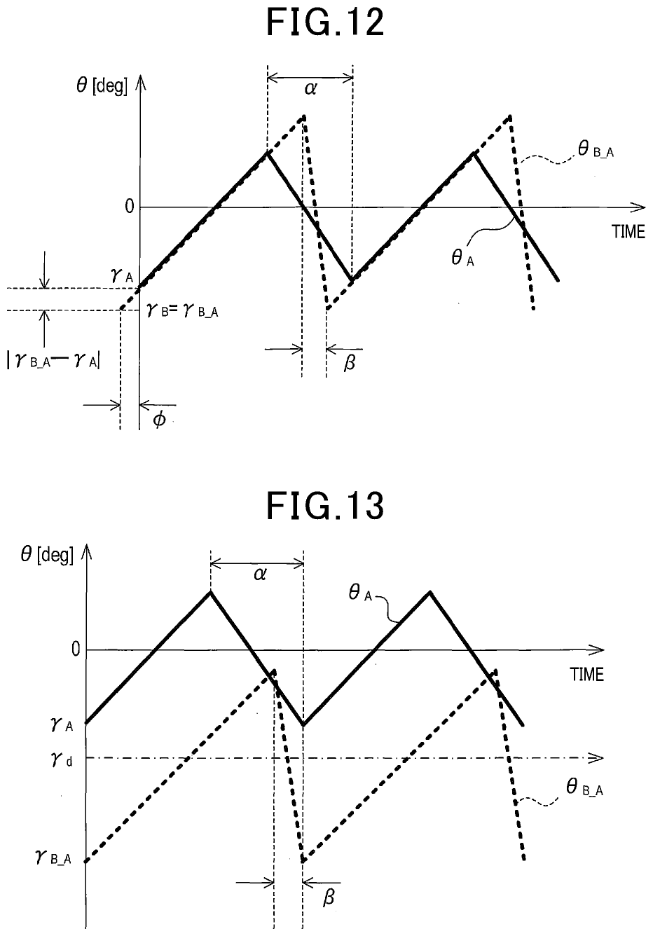

FIG. 12 shows changes in the rotation angle θ_{A} of the deflection member 13 of the ranging unit 10A and the rotation angle θ_{B_A} of the deflection member 13 of the ranging unit 10B in the first arrangement example. Both the rotation angle θ_{A} and the rotation angle θ_{B_A} are expressed as angles determined when the rotation angle for laser light emission in the reference azimuth D_{A} is defined as 0. The values of the rotation angle θ_{A} and the rotation angle θ_{B_A} increase during ranging periods and decrease during non-ranging periods. The non-ranging periods of the ranging unit 10A and the ranging unit 10B are expressed respectively as a non-ranging period α and a non-ranging period β.

The control unit 20 causes the ranging unit 10A to perform its ranging processing and the ranging unit 10B to perform its ranging processing in a manner to prevent the reversal of the magnitude relationship between the emission azimuth angle of laser light emitted by the ranging unit 10A and the emission azimuth angle of laser light emitted by the ranging unit 10B relative to the common reference azimuth D_{A}, as viewed from above in a direction along the rotation axis of the deflection member 13 included in the ranging unit 10A or the ranging unit 10B. This is intended to prevent the passage areas of laser light emitted by the ranging unit 10A and the ranging unit 10B from interfering with each other within the ranging areas. The reversal of the magnitude relationship of the angles refers to a shift of the two angles denoted by 01 and 02 from the state of θ1>θ2 to the state of θ1<θ2 or a shift from the state of θ1<θ2 to the state of θ1>θ2. The reversal of the magnitude relationship of the angles does not include a shift from the state of θ1=θ2 to the state of θ1>θ2 or θ1<θ2, or a shift from the state of θ1>θ2 or θ1<θ2 to the state of θ1=θ2.

The emission azimuth angles of laser light emitted by the ranging unit 10A and the ranging unit 10B relative to the reference azimuth D_{A} are expressed as the rotation angle θ_{A} and the rotation angle θ_{B_A} during the ranging period. Thus, the control unit 20 causes the ranging unit 10A to perform its ranging processing and the ranging unit 10B to perform its ranging processing in a manner to prevent the reversal of the magnitude relationship between the values of the rotation angle θ_{A} and the rotation angle θ_{B_A} in the co-ranging state in which both the ranging unit 10A and the ranging unit 10B are in the ranging period. When the origin position P_{B} is placed in the direction opposite the scanning direction of the ranging unit 10A with respect to the reference line L_{A}, as shown in FIG. 12, the rotation angle θ_{B_A} is not to be greater than the value of the rotation angle θ_{A} in the co-ranging state. The rotation angle θ_{A} relative to the rotation angle θ_{B_A} increases as the time at which the ranging unit 10B starts laser light scanning becomes earlier relative to the time at which the ranging unit 10A starts laser light scanning. However, in the first arrangement example, the opening angle γ_{B_A} is smaller than the starting angle γ_{A}. Thus, the time at which the ranging unit 10B starts laser light scanning may be advanced as long as the rotation angle θ_{B_A} does not exceed the rotation angle θ_{A}. In contrast, if the time at which the ranging unit 10B starts laser light scanning is too late, the ranging period of the ranging unit 10A may start before the end of the ranging period of the ranging unit 10B. In this case, the rotation angle θ_{B_A} exceeds the rotation angle θ_{A}. For this reason, it is necessary to prevent a time delay in the start of laser light scanning by the ranging unit 10B from exceeding the non-ranging period β of the ranging unit 10B.

Thus, in the first arrangement example, the control unit 20 controls the time t at which the ranging unit 10B starts laser light scanning relative to the time at which the ranging unit 10A starts laser light scanning, to be in the range of −Θ≤t≤β In this formula, Θ denotes a period of time taken to move by the angle between the starting azimuth S_{A} and the starting azimuth S_{B} in a rotational manner at the above ranging angular velocity. This control can prevent the passage areas of laser light emitted by the ranging unit 10A and the ranging unit 10B from interfering with each other.

The arrangement example shown in FIG. 9 is another first arrangement example. In the first arrangement example shown in FIG. 11, the reference azimuth D_{A} and the reference azimuth D_{B} are parallel with each other. In the first arrangement example shown in FIG. 9, the reference azimuth D_{A} is facing in the scanning direction of the ranging unit 10A relative to the reference azimuth D_{B}.

FIG. 13 shows changes in the rotation angle θ_{A} and the rotation angle θ_{B_A} in the first arrangement example shown in FIG. 9. As in the first arrangement example shown in FIG. 11, in order to prevent the reversal of the magnitude relationship between the values of the rotation angle θ_{A} and the rotation angle θ_{B_A} in the co-ranging state, the rotation angle θ_{B_A} is not to be greater than the rotation angle θ_{A}. Thus, similarly to the first arrangement example shown in FIG. 11, the control unit 20 can control the time t to be in the range of −Θ≤t≤β, preventing the passage areas of laser light emitted by the ranging unit 10A and the ranging unit 10B from interfering with each other.

### (Second Arrangement Example)

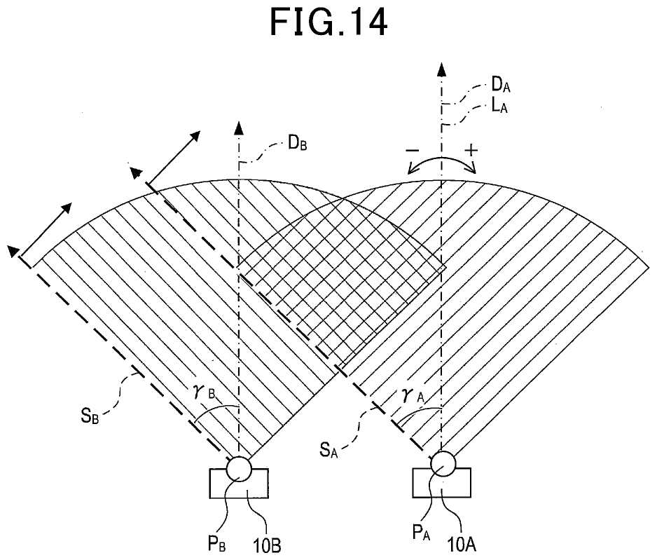

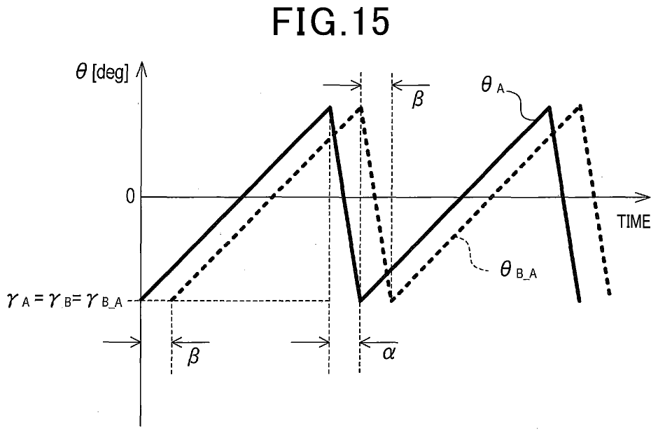

As shown in FIG. 14, a second arrangement example is an example in which the ranging unit 10A and the ranging unit 10B are arranged in such a way that the origin position P_{B} is placed in the direction opposite the scanning direction of the ranging unit 10A with respect to the reference line L_{A}, and the starting angle γ_{A} and the opening angle γ_{B_A} satisfy the relation of γ_{B_A}=γ_{A}.

FIG. 15 shows changes in the rotation angle θ_{A} and the rotation angle θ_{B_A} in the second arrangement example. In the second arrangement example, the opening angle γ_{B_A} is equal to the starting angle γ_{A}. Thus, the time at which the ranging unit 10B starts laser light scanning needs to be the same as or after the time at which the ranging unit 10A starts laser light scanning. However, if the time at which the ranging unit 10B starts laser light scanning is too late, the ranging period of the ranging unit 10A may start before the end of the ranging period of the ranging unit 10B. In this case, the rotation angle θ_{B_A} exceeds the rotation angle θ_{A}. For this reason, it is necessary to prevent a time delay in the start of laser light scanning by the ranging unit 10B from exceeding the non-ranging period β of the ranging unit 10B.

Thus, in the second arrangement example, the control unit 20 controls the time t at which the ranging unit 10B starts laser light scanning relative to the time at which the ranging unit 10A starts laser light scanning, to be in the range of 0≤t≤β. This control can prevent the passage areas of laser light emitted by the ranging unit 10A and the ranging unit 10B from interfering with each other.

### (Third Arrangement Example)

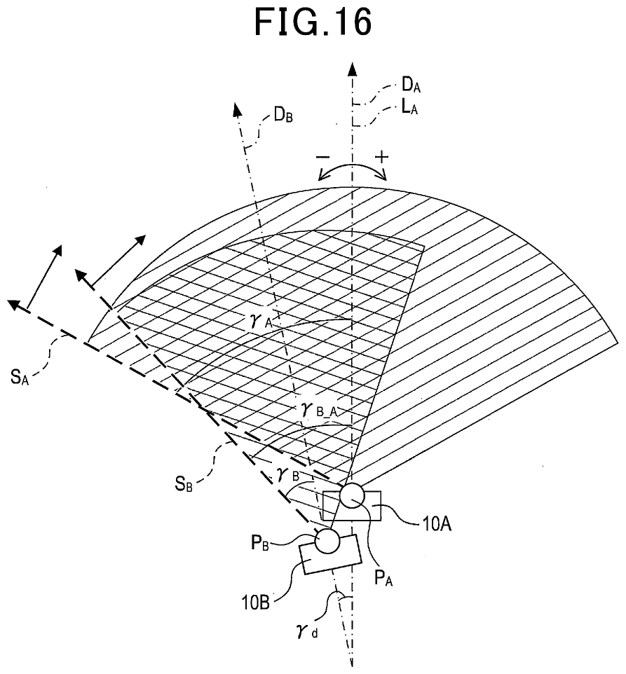

As shown in FIG. 16, a third arrangement example is an example in which the ranging unit 10A and the ranging unit 10B are arranged in such a way that the origin position P_{B} is placed in the direction opposite the scanning direction of the ranging unit 10A with respect to the reference line L_{A}, and the starting angle γ_{A} and the opening angle γ_{B_A} satisfy the relation of γ_{B_A}>γ_{A}. In the third arrangement example shown in FIG. 16, the ranging unit 10A and the ranging unit 10B are arranged with the reference azimuth D_{A} facing in the scanning direction of the ranging unit 10A relative to the reference azimuth D_{B}. However, this is not a condition for the third arrangement example.

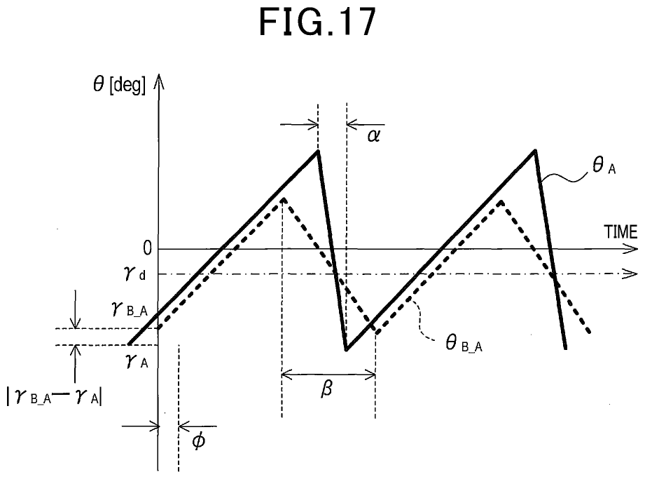

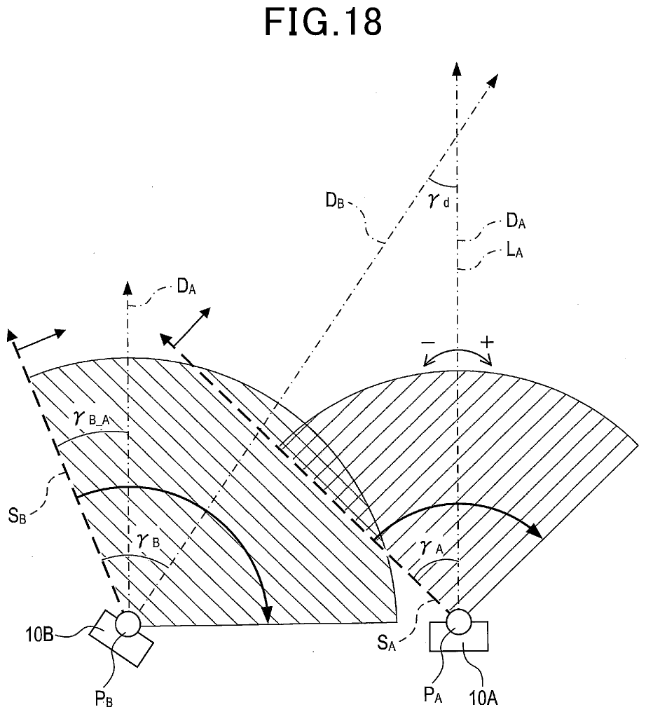

FIG. 17 shows changes in the rotation angle θ_{A} and the rotation angle θ_{B_A} in the third arrangement example. In the third arrangement example, the opening angle γ_{B_A} is greater than the starting angle γ_{A}. Thus, the time at which the ranging unit 10B starts laser light scanning needs to be delayed so that the rotation angle θ_{B_A} does not exceed the rotation angle θ_{A}. However, if the time at which the ranging unit 10B starts laser light scanning is too late, the ranging period of the ranging unit 10A may start before the end of the ranging period of the ranging unit 10B. In this case, the rotation angle θ_{B_A} exceeds the rotation angle θ_{A}. For this reason, it is necessary to prevent a time delay in the start of laser light scanning by the ranging unit 10B from exceeding the non-ranging period β of the ranging unit 10B.

Thus, in the third arrangement example, the control unit 20 controls the time t at which the ranging unit 10B starts laser light scanning relative to the time at which the ranging unit 10A starts laser light scanning, to be in the range of Θ≤t≤β This control can prevent the passage areas of laser light emitted by the ranging unit 10A and the ranging unit 10B from interfering with each other.

The arrangement example shown in FIG. 18 is another example of the third arrangement example. In the third arrangement example shown in FIG. 16, the reference azimuth D_{A} is facing in the scanning direction of the ranging unit 10A relative to the reference azimuth D_{B}. In the third arrangement example shown in FIG. 18, the reference azimuth D_{B} is facing in the scanning direction of the ranging unit 10A relative to the reference azimuth D_{A}.

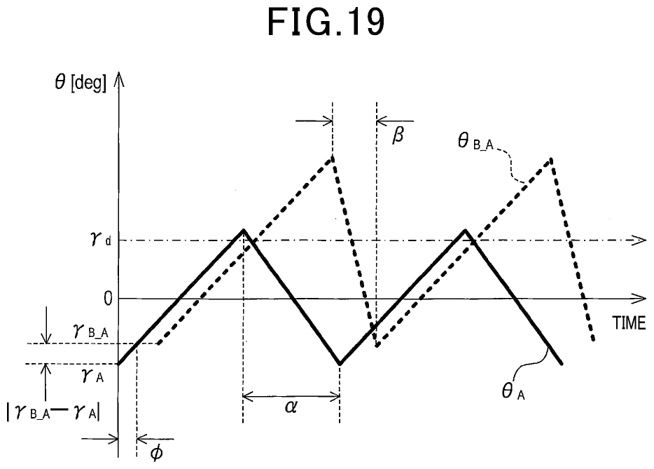

FIG. 19 shows changes in the rotation angle θ_{A} and the rotation angle θ_{B_A} in the third arrangement example shown in FIG. 18. Similarly to the third arrangement example shown in FIG. 16, the control unit 20 can control the time t to be in the range of Θ≤t≤β, preventing the passage areas of laser light emitted by the ranging unit 10A and the ranging unit 10B from interfering with each other.

### (Fourth Arrangement Example)

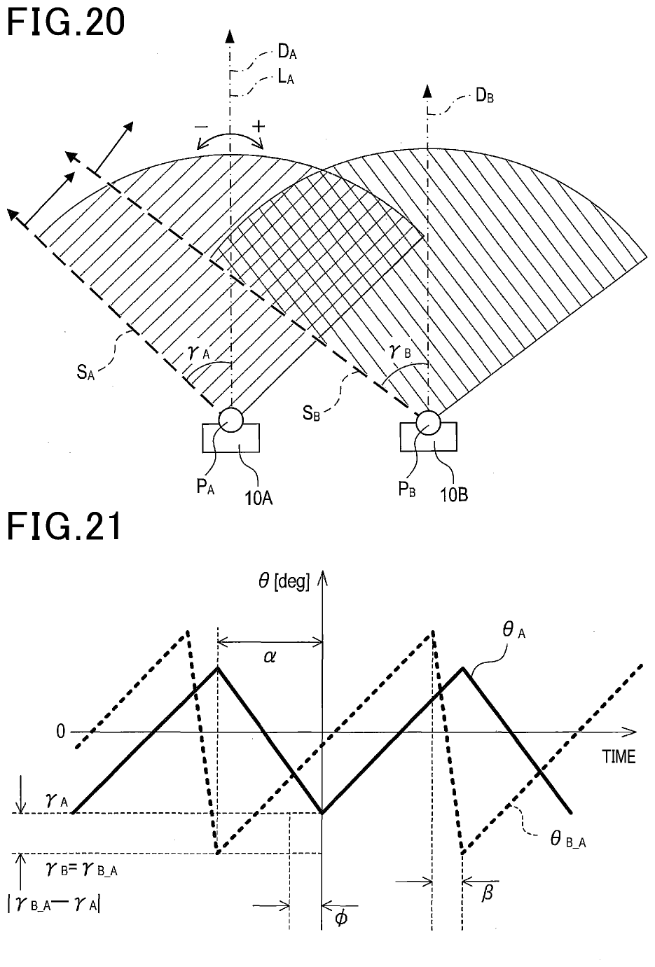

As shown in FIG. 20, a fourth arrangement example is an example in which the ranging unit 10A and the ranging unit 10B are arranged in such a way that the origin position P_{B} is placed in the scanning direction of the ranging unit 10A with respect to the reference line L_{A}, and the starting angle γ_{A} and the opening angle γ_{B_A} satisfy the relation of γ_{B_A}<γ_{A}. In the fourth arrangement example shown in FIG. 20, the ranging unit 10A and the ranging unit 10B are arranged with the reference azimuth D_{A} and the reference azimuth D_{B} parallel to each other. However, this is not a condition for the fourth arrangement example.

The control unit 20 causes the ranging unit 10A to perform its ranging processing and the ranging unit 10B to perform its ranging processing in a manner to prevent the reversal of the magnitude relationship between the emission azimuth angle of laser light emitted by the ranging unit 10A and the emission azimuth angle of laser light emitted by the ranging unit 10B relative to the common reference azimuth D_{A}, as viewed from above in a direction along the rotation axis of the deflection member 13 included in the ranging unit 10A or the ranging unit 10B. This is intended to prevent the passage areas of laser light emitted by the ranging unit 10A and the ranging unit 10B from interfering with each other within the ranging areas. Specifically, the control unit 20 causes the ranging unit 10A to perform its ranging processing and the ranging unit 10B to perform its ranging processing in a manner to prevent the reversal of the magnitude relationship between the values of the rotation angle θ_{A} and the rotation angle θ_{B_A} in the co-ranging state.

FIG. 21 shows changes in the rotation angle θ_{A} and the rotation angle θ_{B_A} in the fourth arrangement example. When the origin position P_{B} is placed in the scanning direction of the ranging unit 10A with respect to the reference line L_{A}, as shown in FIG. 21, the rotation angle θ_{B_A} is not to be smaller than the rotation angle θ_{A}. In the fourth arrangement example, the opening angle γ_{B_A} is greater than the starting angle γ_{A}. Thus, the time at which the ranging unit 10B starts laser light scanning needs to be advanced so that the rotation angle θ_{B_A} does not fall below the rotation angle θ_{A}. However, if the time at which the ranging unit 10B starts laser light scanning is too early, the ranging period of the ranging unit 10B may start before the end of the ranging period of the ranging unit 10A. In this case, the rotation angle θ_{B_A} falls below the rotation angle θ_{A}. For this reason, it is necessary to prevent the start of laser light scanning by the ranging unit 10B from leading by a time longer than the non-ranging period a of the ranging unit 10A.

Thus, in the fourth arrangement example, the control unit 20 controls the time t at which the ranging unit 10B starts laser light scanning relative to the time at which the ranging unit 10A starts laser light scanning, to be in the range of −α≤t≤−Θ. This control can prevent the passage areas of laser light emitted by the ranging unit 10A and the ranging unit 10B from interfering with each other.

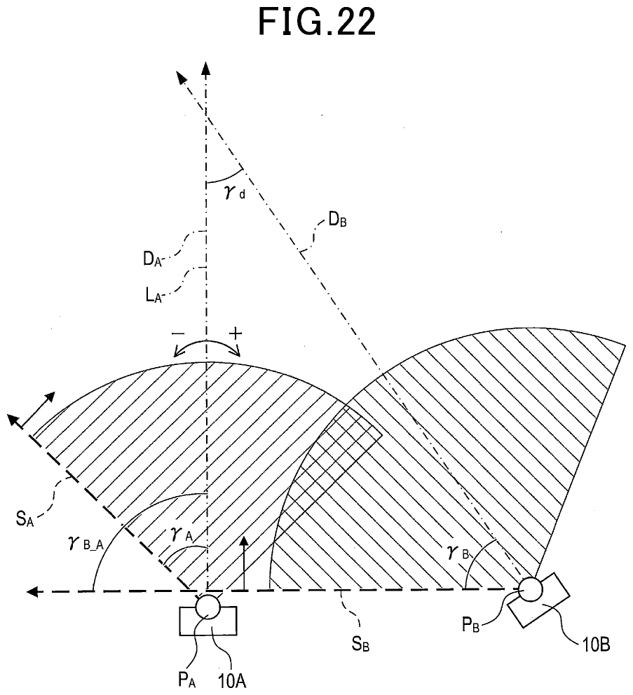

The arrangement example shown in FIG. 22 is another example of the fourth arrangement example. In the fourth arrangement example shown in FIG. 20, the reference azimuth D_{A} and the reference azimuth D_{B} are parallel with each other. In the fourth arrangement example shown in FIG. 22, the reference azimuth D_{A} is facing in the scanning direction of the ranging unit 10A relative to the reference azimuth D_{B}.

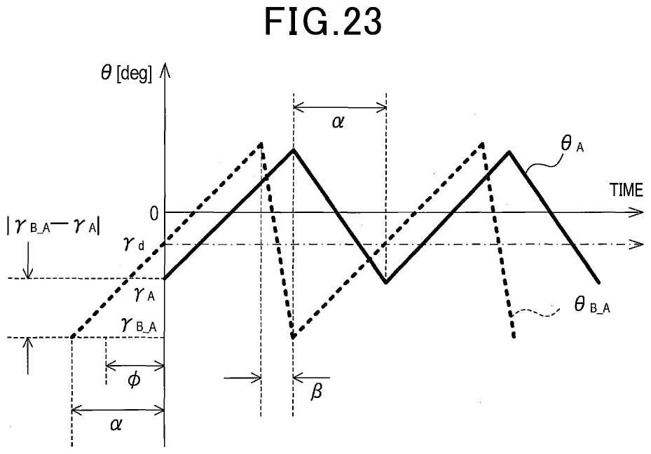

FIG. 23 shows changes in the rotation angle θ_{A} and the rotation angle θ_{B_A} in the fourth arrangement example shown in FIG. 22. Similarly to the fourth arrangement example shown in FIG. 20, the control unit 20 can control the time t to be in the range of −α≤t≤−Θ, preventing the passage areas of laser light emitted by the ranging unit 10A and the ranging unit 10B from interfering with each other.

The fourth arrangement example may be regarded as an arrangement example in which the ranging unit 10A and the ranging unit 10B in the third arrangement example are interchanged. That is, the fourth arrangement example is substantially the same as the third arrangement example.

### (Fifth Arrangement Example)

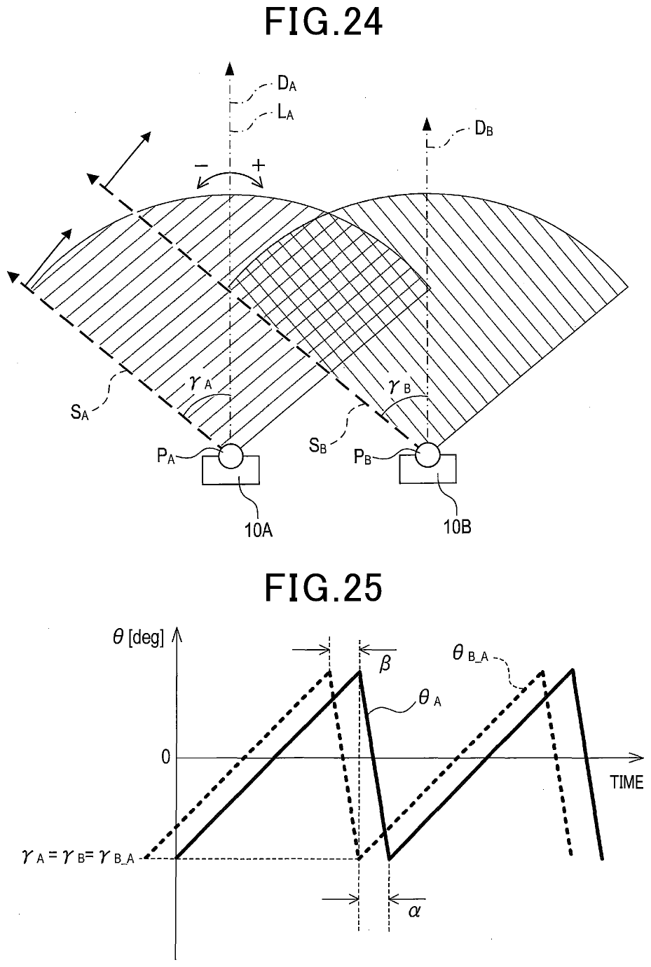

As shown in FIG. 24, a fifth arrangement example is an example in which the ranging unit 10A and the ranging unit 10B are arranged in such a way that the origin position P_{B} is placed in the scanning direction of the ranging unit 10A with respect to the reference line L_{A}, and the starting angle γ_{A} and the opening angle γ_{B_A} satisfy the relation of γ_{B_A}=γ_{A}.

FIG. 25 shows changes in the rotation angle θ_{A} and the rotation angle θ_{B_A} in the fifth arrangement example. In the fifth arrangement example, the opening angle γ_{B_A} is equal to the starting angle γ_{A}. Thus, the time at which the ranging unit 10B starts laser light scanning needs to be the same as or after the time at which the ranging unit 10A starts laser light scanning. However, if the time at which the ranging unit 10B starts laser light scanning is too early, the ranging period of the ranging unit 10B may start before the end of the ranging period of the ranging unit 10A. In this case, the rotation angle θ_{B_A} falls below the rotation angle θ_{A}. For this reason, it is necessary to prevent the start of laser light scanning by the ranging unit 10B from leading by a time longer than the non-ranging period α of the ranging unit 10A.

Thus, in the fifth arrangement example, the control unit 20 controls the time t at which the ranging unit 10B starts laser light scanning relative to the time at which the ranging unit 10A starts laser light scanning, to be in the range of −α≤t≤0. This control can prevent the passage areas of laser light emitted by the ranging unit 10A and the ranging unit 10B from interfering with each other.

The fifth arrangement example may be regarded an arrangement example in which the ranging unit 10A and the ranging unit 10B in the second arrangement example are interchanged. That is, the fifth arrangement example is substantially the same as the second arrangement example.

### (Sixth Arrangement Example)

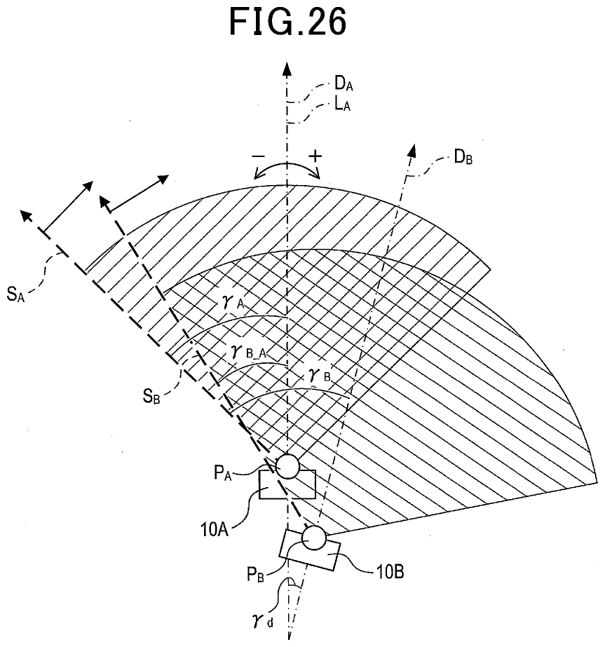

As shown in FIG. 26, a sixth arrangement example is an example in which the ranging unit 10A and the ranging unit 10B are arranged in such a way that the origin position P_{B} is placed in the scanning direction of the ranging unit 10A with respect to the reference line L_{A}, and the starting angle γ_{A} and the opening angle γ_{B_A} satisfy the relation of γ_{B_A}>γ_{A}. In the sixth arrangement example shown in FIG. 26, the ranging unit 10A and the ranging unit 10B are arranged with starting angle γ_{B}, the shifted position angle γ_{d}, and the opening angle γ_{B_A} satisfying the relation of γ_{B_A}=γ_{B}—γ_{d}. However, this is not a condition for the sixth arrangement example.

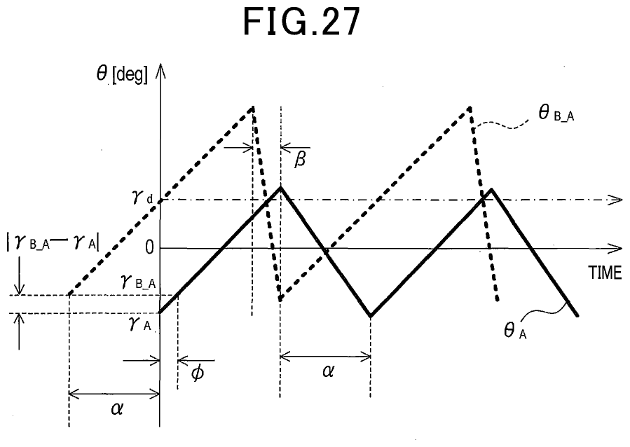

FIG. 27 shows changes in the rotation angle θ_{A} and the rotation angle θ_{B_A} in the sixth arrangement example. In the sixth arrangement example, the opening angle γ_{B_A} is smaller than the starting angle γ_{A}. Thus, the time at which the ranging unit 10B starts laser light scanning may be delayed as long as the rotation angle θ_{B_A} does not fall below the rotation angle θ_{A}. In contrast, if the time at which the ranging unit 10B starts laser light scanning is too early, the ranging period of the ranging unit 10B may start before the end of the ranging period of the ranging unit 10A. In this case, the rotation angle θ_{B_A} falls below the rotation angle θ_{A}. For this reason, it is necessary to prevent the start of laser light scanning by the ranging unit 10B from leading by a time longer than the non-ranging period a of the ranging unit 10A.

Thus, in the sixth arrangement example, the control unit 20 controls the time t at which the ranging unit 10B starts laser light scanning, relative to the time at which the ranging unit 10A starts laser light scanning, to be in the range of −α≤t≤Θ. This control can prevent the passage areas of laser light emitted by the ranging unit 10A and the ranging unit 10B from interfering with each other.

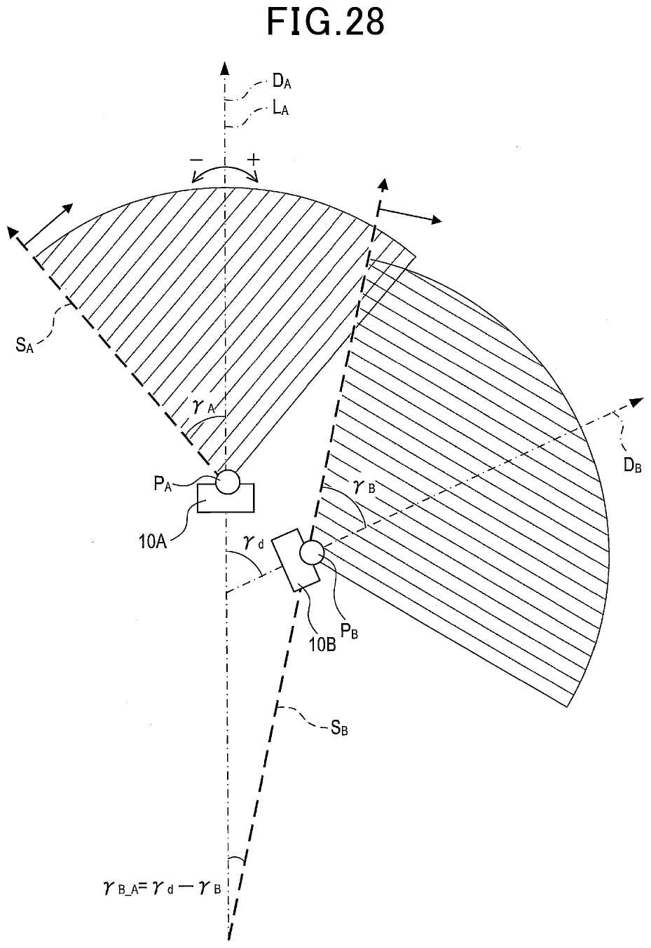

The arrangement example shown in FIG. 28 is another sixth arrangement example. In the sixth arrangement example shown in FIG. 26, the starting angle γ_{B}, the shifted position angle γ_{d}, and the opening angle γ_{B_A} satisfy the relation of γ_{B_A}=γ_{B}−γ_{d}. In the arrangement example shown in FIG. 28, the starting angle γ_{B}, the shifted position angle γ_{d}, and the opening angle γ_{B_A} satisfy the relation of γ_{B_A}=γ_{d}−γ_{B}.

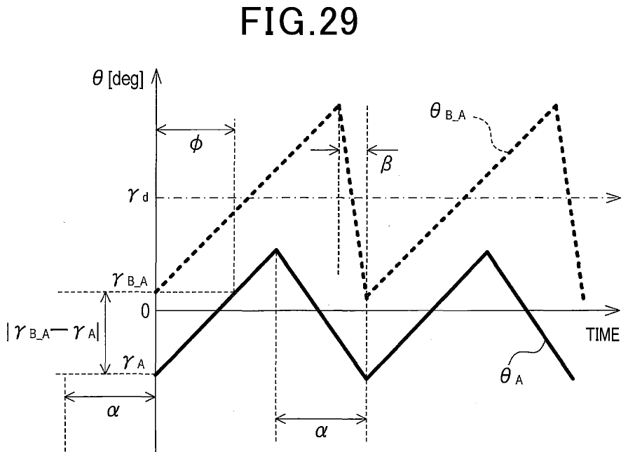

FIG. 29 shows changes in the rotation angle θ_{A} and the rotation angle θ_{B_A} in the sixth arrangement example shown in FIG. 28. Similarly to the sixth arrangement example shown in FIG. 26, the control unit 20 can control the time t to be in the range of −α≤t≤Θ, preventing the passage areas of laser light emitted by the ranging unit 10A and the ranging unit 10B from interfering with each other.

The sixth arrangement example may be regarded as an arrangement example in which the ranging unit 10A and the ranging unit 10B in the first arrangement example are interchanged. That is, the sixth arrangement example is substantially the same as the first arrangement example.

### [1-5. Mechanism for Diversifying Scan Timing of Multiple Ranging Units]

The control unit 20 according to the present embodiment prevents erroneous measurement as described above as well as controls each ranging unit to diversify the scan timing of the multiple ranging units. Specifically, the control unit 20 controls each ranging unit to cause the ranging units to change the angular velocities of their deflection members 13 at different times. The control unit 20 also controls each ranging unit to cause the periods of the deflection members 13 having the highest angular velocities to have at least a non-overlapping time between the ranging units. Although a configuration with two ranging units is described below, the same applies to a configuration with three or more ranging units.

### [1-5-1. Mechanism for Causing Multiple Ranging Units to Switch at Different Times]

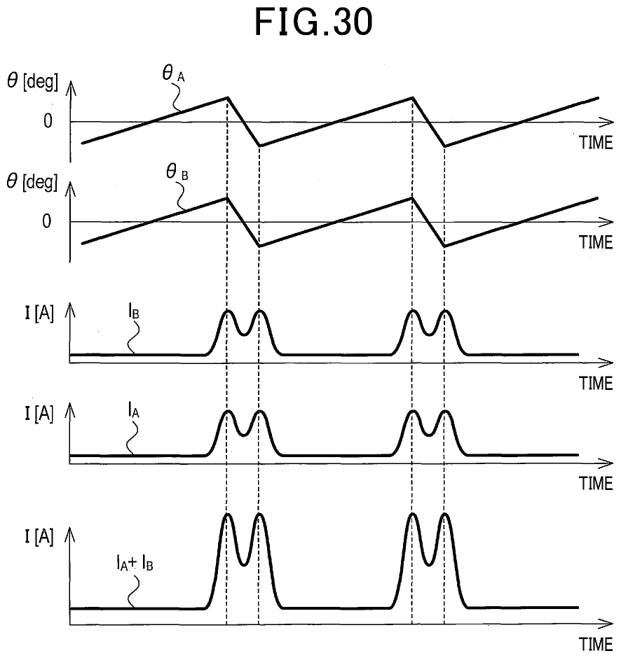

In the ranging processing in the present embodiment, ranging periods alternate with non-ranging periods. Accordingly, as shown in FIG. 30, the rotation angle θ_{A} of the deflection member 13 in the ranging unit 10A and the rotation angle θ_{B} of the deflection member 13 in the ranging unit 10B increase for ranging periods and decrease for non-ranging periods. The rotation angle θ_{B} is expressed as an angle determined when the rotation angle for laser light emission in the reference azimuth D_{B} is defined as 0. The current flowing in the drive 12 of the ranging unit 10A has a value I_{A} and the current flowing in the drive 12 of the ranging unit 10B has a value IB, and each value surges when the control unit 20 changes the angular velocity of the deflection member 13, or in other words, at switching between a ranging period and a non-ranging period. Thus, as shown in FIG. 30, when multiple ranging units switch at the same time, and instantaneous currents peak at the same time, the instantaneous current in the whole vehicle 100 increases, causing noise in electrical signals output from the light receiver 14. Furthermore, the power supply for the whole vehicle 100 is designed to have redundancy based on the cumulative instantaneous current.

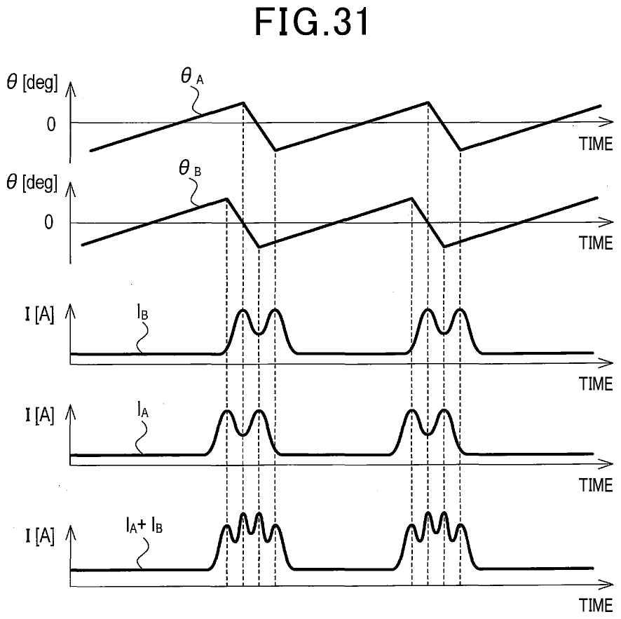

Thus, as shown in FIG. 31, the control unit 20 controls the multiple ranging units so that the ranging units switch at different times, or in other words, the switching is staggered. This control reduces the likelihood that instantaneous currents peak at the same time, preventing an increase in the instantaneous current in the whole vehicle 100.

### [1-5-2. Mechanism for Reducing Likelihood of Coinciding Periods of Deflection Members Having Highest Angular Velocities]

During the period of the deflection member 13 having the highest angular velocity, the value I_{A} of the current flowing in the drive 12 of the ranging unit 10A and the value IB of the current flowing in the drive 12 of the ranging unit 10B are greater than in the other period. As shown in FIG. 30, in the present embodiment, the ranging unit is controlled so that the angular velocity of the deflection member 13 in the non-ranging period is higher than the ranging angular velocity. That is, in the present embodiment, the non-ranging period is the period during which the deflection member 13 has the highest angular velocity. In this case, the value I_{A} of the current flowing in the drive 12 of the ranging unit 10A and the value IB of the current flowing in the drive 12 of the ranging unit 10B are greater during non-ranging periods than during ranging periods. Accordingly, for example, as shown in FIG. 30, when multiple ranging units have coinciding non-ranging periods, the current in the whole vehicle 100 increases, causing noise in electrical signals output from the light receiver 14. Furthermore, the power supply for the whole vehicle 100 is designed to have redundancy based on the cumulative instantaneous current.

Thus, as shown in FIG. 31, the control unit 20 in the present embodiment controls the multiple ranging units to cause the non-ranging periods to have at least a non-overlapping time between the ranging units. For example, when the non-ranging periods of two ranging units have different lengths, it is inevitable that the longer non-ranging period does not precisely coincide with the shorter non-ranging period. Thus, such an example also means that the shorter non-ranging period does not precisely coincide with the longer non-ranging period. This control prevents an increase in the current in the whole vehicle 100.

### [1-6. Effects]

The embodiment described in detail above provides the following effects.

(1a) The ranging device 1 causes each ranging unit to perform its ranging processing in a manner to prevent the passage areas of laser light emitted by the multiple ranging units from interfering with each other within the ranging areas. This mechanism can prevent ranging units having overlapping ranging areas from erroneously measuring a distance to an object. In particular, the ranging device 1 causes the ranging units to perform ranging processing in parallel with each other and thus completes ranging processing on every ranging area more quickly than a mechanism in which ranging units do not perform ranging processing in parallel.

(1b) The ranging device 1 causes the ranging unit 10A to perform its ranging processing and the ranging unit 10B to perform its ranging processing in a manner to prevent the reversal of the magnitude relationship between the emission azimuth angle of laser light emitted by the ranging unit 10A and the emission azimuth angle of laser light emitted by the ranging unit 10B relative to the common reference azimuth D_{A}, as viewed from above in a direction along the rotation axis of the deflection member 13 included in the ranging unit 10A or the ranging unit 10B. This mechanism can prevent the passage areas of laser light emitted by the ranging units from interfering with each other within the ranging areas.

(1c) The ranging device 1 causes each ranging unit to perform ranging processing in the same ranging cycle. This mechanism enables, by, for example, controlling the time to start laser light scanning, the phase difference between the ranging cycles of the ranging units to be set without the reversal of the magnitude relationship between the emission azimuth angle of laser light emitted by the ranging unit 10A and the emission azimuth angle of laser light emitted by the ranging unit 10B with respect to the common reference azimuth D_{A}.

(1d) A ranging cycle includes a non-ranging period. This mechanism can prevent the passage areas of laser light emitted by the ranging units from interfering with each other within the ranging areas and also increase the flexibility to design parameters such as the time to start laser light scanning.

(1e) The ranging device 1 controls the times at which the two ranging units arranged with their ranging areas overlapping with each other start laser light scanning. The control is performed so that the rotation angle of the deflection member 13 in the ranging unit placed in the scanning direction does not exceed the rotation angle of the deflection member 13 in the ranging unit placed in the direction opposite the scanning direction. This mechanism can prevent the passage areas of laser light emitted by the ranging units from interfering with each other within the ranging areas.

(1f) The ranging device 1 controls the multiple ranging units so that the ranging units switch at different times. This mechanism can prevent instantaneous currents from peaking at the same time and also prevent an increase in the instantaneous current in the whole vehicle 100.

(1g) The ranging device 1 controls the multiple ranging units to cause the periods of the deflection members 13 having the highest angular velocities to have at least a non-overlapping time between the ranging units. This mechanism can prevent instantaneous currents from peaking at the same time and also prevent an increase in the current in the whole vehicle 100.

### 2. Second Embodiment

The second embodiment is basically similar to the first embodiment, and thus common components will not be described, whereas differences will be mainly described. The same reference numerals as in the first embodiment represent the same components and refer to the foregoing description and the drawings.

In the second embodiment, similarly to the first embodiment, the control unit 20 causes each ranging unit to perform ranging processing in the same scanning direction and ranging cycle. However, in the second embodiment, the control unit 20 causes the ranging units to perform ranging processing at different ranging angular velocities.

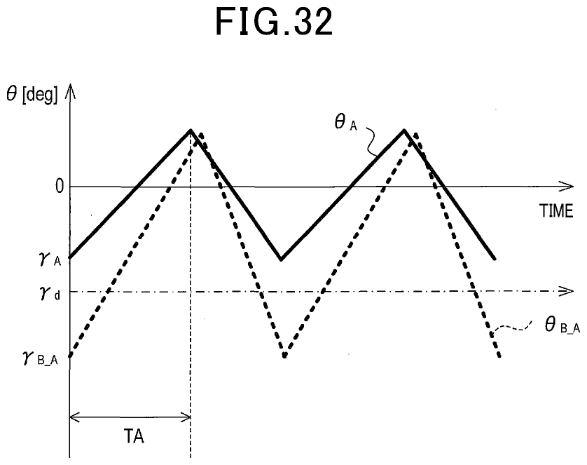

In the second embodiment, the ranging unit 10A and the ranging unit 10B are arranged as shown in FIG. 9. However, the ranging angular velocity of the ranging unit 10A denoted by ω_{A} is greater than the ranging angular velocity of the ranging unit 10B denoted by ω_{B}. In order to prevent the passage areas of laser light emitted by the ranging unit 10A and the ranging unit 10B from interfering with each other within the ranging areas, as shown in FIG. 32, the rotation angle θ_{B_A} is set to be not greater than the rotation angle θ_{A} during a period TA of the co-ranging state. In FIG. 32, the ranging angular velocity ω_{A} and the ranging angular velocity ω_{B} are expressed respectively by the slopes of the lines representing the values of θ_{A} and θ_{B_A} during the respective ranging periods of the ranging unit 10A and the ranging unit 10B. The gap between the rotation angle θ_{A} and the rotation angle θ_{B_A} narrows rapidly as the ranging angular velocity ω_{B} of the ranging unit 10B increases relative to the ranging angular velocity ω_{A} of the ranging unit 10A. In addition, as the period TA of the co-ranging state becomes longer, the gap between the rotation angle θ_{A} and the rotation angle θ_{B_A} narrows.

Thus, the control unit 20 controls the ranging angular velocity ω_{A} of the ranging unit 10A and the ranging angular velocity ω_{B} of the ranging unit 10B to cause the period TA of the co-ranging state to be equal to or smaller than the value obtained by dividing the angle between the emission azimuths of the ranging unit 10A and the ranging unit 10B at the start of the co-ranging state by the difference between the ranging angular velocities of a second ranging unit and a first ranging unit in the co-ranging state.

If the time at which the ranging unit 10B starts laser light scanning is too late, the ranging period of the ranging unit 10A may start before the end of the ranging period of the ranging unit 10B. In this case, the rotation angle θ_{B_A} exceeds the rotation angle θ_{A}. Furthermore, if the time at which the ranging unit 10B starts laser light scanning is too early, the ranging period of the ranging unit 10B may start before the end of the ranging period of the ranging unit 10A. Also in this case, the rotation angle θ_{B_A} exceeds the rotation angle θ_{A}.

Thus, the control unit 20 controls the time at which the ranging unit 10B starts laser light scanning relative to the time at which the ranging unit 10A starts laser light scanning so that the scanning period controlled falls within the range defined by the lower limit that is the value representing the non-ranging period of the ranging unit 10A and the upper limit that is the value representing the non-ranging period of the ranging unit 10B. In other words, the control unit 20 controls the time t at which the ranging unit 10B starts laser light scanning relative to the time at which the ranging unit 10A starts laser light scanning, to be in the range of α≤t≤β.

In an example in which the ranging unit 10A and the ranging unit 10B start laser light scanning at the same time, the control unit 20 controls the ranging angular velocity ω_{A} of the ranging unit 10A and the ranging angular velocity ω_{B} of the ranging unit 10B so that the ranging angular velocity ω_{A} and the ranging angular velocity ω_{B} satisfy the relation of TA≤|γ_{B_A}−γ_{A}|/(ω_{B}−ω_{A}).

This control can prevent the passage areas of laser light emitted by the ranging unit 10A and the ranging unit 10B from interfering with each other within the ranging areas.

### 3. Other Embodiments

Although the embodiments of the present disclosure have been described above, it is needless to say that the disclosure may take a variety of forms without being limited to the embodiments.

(3a) In each embodiment described above, each ranging unit performs ranging processing at least in the same scanning direction and the same ranging cycle. However, unlike those example mechanisms, at least one of them may not be the same. For example, the ranging processing may be performed in different ranging cycles.

(3b) In each embodiment described above, the control unit 20 has both the function of controlling the operation of each ranging unit and the function of centrally controlling the ranging processing by each ranging unit. However, the control unit 20 is not limited to those example mechanisms. For example, the function of controlling the operation of each ranging unit may be distributed among the ranging units. For example, in this case, the function of centrally controlling the ranging processing by each ranging unit may be implemented through communication between the control units included in the respective ranging units or may be implemented through control by a control unit other than these control units.

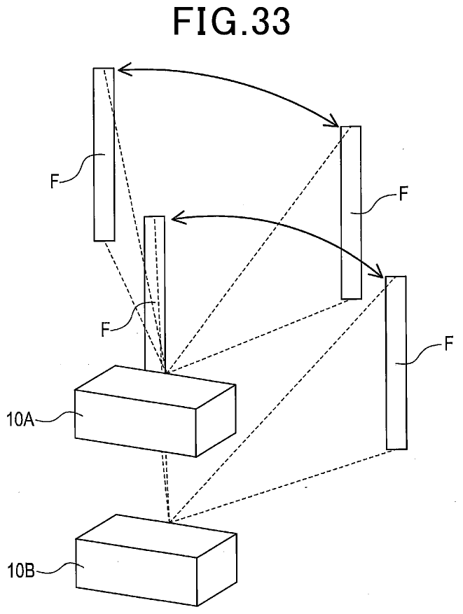

(3c) In each embodiment described above, the ranging units are aligned in the scanning direction. However, as shown in FIG. 33, the ranging unit 10A and the ranging unit 10B may be aligned in the direction of the rotation axes of the deflection members 13. In this case, each ranging unit is arranged in such a way that the ranging area overlaps with the ranging area of the adjacent ranging unit in the direction of the rotation axis of the deflection member 13. In the example shown in FIG. 33, each ranging unit scans with long laser light having a cross-sectional shape F extending in a direction orthogonal to the scanning direction. The control unit 20 causes each ranging unit to perform ranging processing in a manner to prevent the passage areas of laser light emitted by the multiple ranging units from interfering with each other within an overlap between the ranging areas. For example, with the same scanning direction, the same ranging cycle, and the same ranging angular velocity, the rotation angle θ_{A} and the rotation angle θ_{B_A} are to be different from each other. Specifically, when laser light scanning has the same angular range during the ranging periods, the scan timing is staggered. When laser light scanning has different angular ranges during the ranging periods, the scan timing is adjusted as long as the scans are not synchronized.

(3d) In the second embodiment described above, the ranging unit 10B of the ranging unit 10A and the ranging unit 10B is placed in the direction opposite the scanning direction of the ranging unit 10A, and the ranging angular velocity ω_{B} is greater than the ranging angular velocity ω_{A}. However, the arrangement of each ranging unit and the magnitude relationship of the ranging angular velocities are not limited to this example configuration. For example, the ranging unit 10B of the ranging unit 10A and the ranging unit 10B may be placed in the scanning direction of the ranging unit 10A, and the ranging angular velocity ω_{A} may be greater than the ranging angular velocity WB.

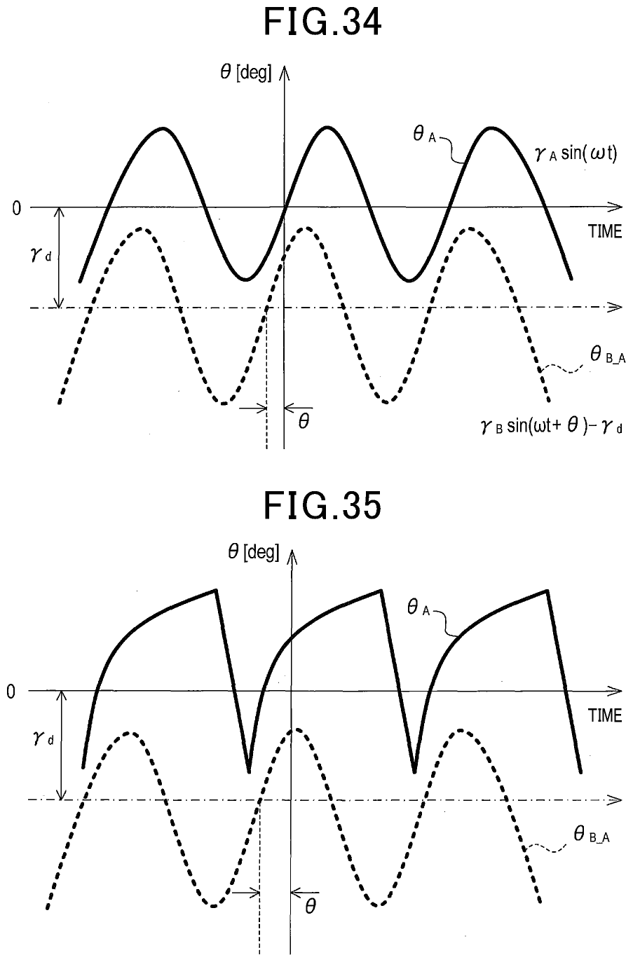

(3e) In each embodiment described above, for example, as shown in FIG. 12, the drives 12 move the deflection members 13 of the ranging unit 10A and the ranging unit 10B in a rotational manner in such a way that changes in both the rotation angles represent periodic waveforms. Specifically, the rotational movement causes ranging periods to alternate with non-ranging periods in the form of triangular waves. However, the rotational movement of the deflection members 13 is not limited to the example mechanism. For example, as shown in FIG. 34, the drives 12 may move the deflection members 13 in a rotational manner in such a way that changes in the rotation angles represent sinusoidal waveforms. In this example, the entire ranging cycle is the ranging period. For example, with the same ranging cycle, the sinusoidal waves representing changes in the rotation angles of the deflection members 13 of the ranging unit 10A and the ranging unit 10B are expressed respectively by formulas (1) and (2) below.

### [Math. 1]

θ_{A}=γ_{A} sin(ωt) (1)

θ_{B_A}=γ_{B} sin(ωt+θ)−γ_{d} (2)

In the formulas, ω denotes the angular velocity of the deflection members 13 of the ranging unit 10A and the ranging unit 10B, t denotes time, and θ denotes the phase difference θ between θ_{A} and θ_{B_A}.

With the ranging unit 10A and the ranging unit 10B arranged as shown in FIG. 9, the rotation angle θ_{B_A} is not to be greater than the value of the rotation angle θ_{A} in the co-ranging state so as to prevent the passage areas of laser light emitted by the ranging unit 10A and the ranging unit 10B from interfering with each other. Accordingly, the relation of formula (3) below is to be satisfied, and therefore, θ is to be set in a manner to satisfy the relation of formula (4).

$$\begin{matrix}[ Math . 2 ] & \\ {γ}_{A} sin ( ω t ) \geq {γ}_{B} sin ( ω t + θ ) - {γ}_{d} & ( 3 ) \\ θ \leq {sin}^{- 1} ( \frac{{γ}_{A} sin ( ω t ) + {γ}_{d}}{{γ}_{B}} ) - ω t & ( 4 )\end{matrix}$$

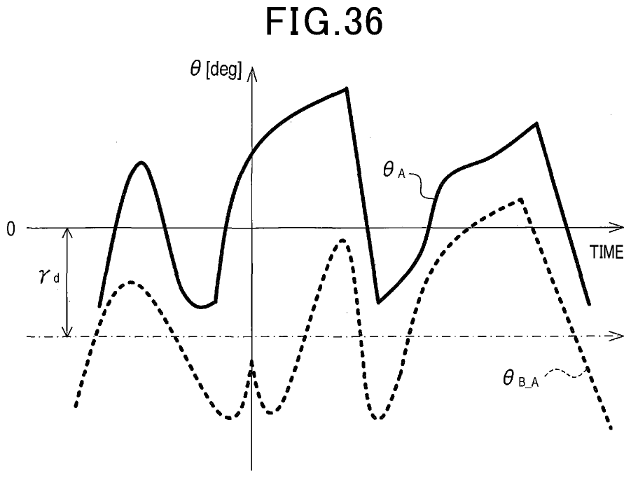

In some examples, as shown in FIG. 35, the drives 12 may move the deflection members 13 of the ranging unit 10A and the ranging unit 10B in a rotational manner in such a way that changes in the rotation angles represent waveforms different from each other. In other examples, as shown in FIG. 36, the drives 12 may move the deflection members 13 of the ranging unit 10A and the ranging unit 10B in a rotational manner without periodicity.

(3f) In each embodiment described above, the drive 12 swings the deflection member 13. However, the drive 12 may rotate the deflection member 13.

(3g) In each embodiment described above, control is performed to prevent the passage areas of laser light emitted by the multiple ranging units from interfering with each other within the ranging areas as well as outside the ranging areas. However, the passage areas of laser light may be permitted to interfere with each other outside the ranging areas.

(3h) In each embodiment described above, the three ranging units are arranged to have ranging areas in front of the vehicle 100. However, the number and arrangement of ranging units are not limited to the example. For example, two or four or more ranging units may be arranged to have ranging areas behind the vehicle 100.

(3i) In each embodiment described above, the ranging device 1 is illustrated as being installed in the vehicle 100. However, the ranging device is not limited to the example. For example, the ranging device may be mounted on a moving object other than a vehicle, or more specifically, on a flying object such as a drone.

(3j) In each embodiment described above, the drive 12 is a motor. However, the drive 12 is not limited to the example. For example, the drive 12 may also be a MEMS. MEMS stands for microelectromechanical systems.

(3k) In each embodiment described above, the deflection member 13 is a mirror. However, another deflection member capable of deflecting laser light, such as a prism, may also be used as the deflection member 13.

(3l) The configuration of the ranging unit shown in FIG. 3 is a mere example, and another configuration may also be used. For example, the ranging unit may have a configuration in which laser light from the projector 11 may pass through a semi-transparent mirror to the deflection member 13, and reflected light from the deflection member 13 may be reflected by the semi-transparent mirror and received by the light receiver 14.

(3m) The functions of a single component in the above embodiments may be distributed as multiple components, or the functions of multiple components may be integrated into a single component. Some of the components in the above embodiments may be omitted. At least some components in one of the above embodiments may be added to or substituted for components in another of the above embodiments.

What is claimed is:

1. A ranging device comprising:
a plurality of ranging units; and
a control unit configured to control the plurality of ranging units, wherein
each of the plurality of ranging units includes a deflection member configured to deflect laser light and is configured to perform ranging processing that scans a predetermined ranging area with the emitted laser light by rotating or oscillating the deflection member to change an emission azimuth of the laser light, and measures a distance to an object located in the emission azimuth based on reflected light received from an azimuth identical to the emission azimuth,
the plurality of ranging units include a first ranging unit and a second ranging unit with the ranging areas overlapping with each other, and
the control unit causes the first ranging unit to perform the ranging processing and the second ranging unit to perform the ranging processing in parallel with each other in a manner to prevent a first passage area traveled by the laser light emitted by the first ranging unit and a second passage area traveled by the laser light emitted by the second ranging unit from interfering with each other in the ranging areas.

2. The ranging device according to claim 1, wherein
the first ranging unit and the second ranging unit each include a projector configured to emit the laser light and a light receiver configured to receive the reflected light of the laser light, and
each of the light receivers is arranged to receive the reflected light from an azimuth identical to the emission azimuth of the laser light.

3. The ranging device according to claim 2, wherein
the reflected light from the azimuth identical to the emission azimuth is reflected by the deflection member for deflecting the laser light and received by the light receiver.

4. The ranging device according to claim 1, wherein
the control unit causes the first ranging unit to perform the ranging processing and the second ranging unit to perform the ranging processing in a manner to prevent reversal of a magnitude relationship between angles of the emission azimuth of laser light emitted by the first ranging unit and the emission azimuth of laser light emitted by the second ranging unit relative to a common reference azimuth, as viewed from above in a direction along a rotation axis of the deflection member included in the first ranging unit or the second ranging unit.

5. The ranging device according to claim 4, wherein
the control unit causes the first ranging unit to perform the ranging processing and the second ranging unit to perform the ranging processing in identical ranging cycles in which distance measurement is performed.

6. The ranging device according to claim 5, wherein
the ranging cycle includes a ranging period during which distance measurement is performed and a non-ranging period during which no distance measurement is performed, and
the control unit causes the first ranging unit to perform the ranging processing and the second ranging unit to perform the ranging processing in a manner to prevent the first passage area and the second passage area from interfering with each other in the ranging areas with the first ranging unit and the second ranging unit both in the ranging period.

7. The ranging device according to claim 6, wherein
the control unit causes the first ranging unit to perform the ranging processing and the second ranging unit to perform the ranging processing in identical scanning directions for the laser light scanning and at identical ranging angular velocities being rotating or oscillating angular velocities of the deflection members during the ranging period,
the first ranging unit and the second ranging unit are aligned in the scanning direction with the rotation axis of the deflection member of the first ranging unit placed in the scanning direction with respect to the rotation axis of the deflection member of the second ranging unit, and
the second ranging unit starts the laser light scanning at a relative time which is relative to a time at which the first ranging unit starts the laser light scanning, the relative time being within a range defined by an upper limit being a value representing the non-ranging period of the second ranging unit and a lower limit being a value representing a period of time taken to move an angle, in a rotational manner at the ranging angular velocity, between a first starting azimuth being the emission azimuth in which the first ranging unit starts the laser light scanning and a second starting azimuth being the emission azimuth in which the second ranging unit starts the laser light scanning, the lower value having a negative sign when the first starting azimuth is facing in the scanning direction relative to the second starting azimuth.

8. The ranging device according to claim 4, wherein
the control unit causes the first ranging unit to perform the ranging processing and the second ranging unit to perform the ranging processing at different ranging angular velocities being rotating or oscillating angular velocities of the deflection members during a period during which distance measurement is performed.

9. The ranging device according to claim 8, wherein
the ranging cycle in which distance measurement is performed includes a ranging period during which distance measurement is performed and a non-ranging period during which no distance measurement is performed, and
the control unit causes the first ranging unit to perform the ranging processing and the second ranging unit to perform the ranging processing in a manner to prevent the first passage area and the second passage area from interfering with each other in the ranging areas in a co-ranging state in which the first ranging unit and the second ranging unit are both in the ranging period.

10. The ranging device according to claim 9, wherein
the control unit causes the first ranging unit to perform the ranging processing and the second ranging unit to perform the ranging processing in the same ranging cycle and in identical scanning directions for laser light scanning,
the first ranging unit and the second ranging unit are aligned in the scanning direction with the rotation axis of the deflection member of the first ranging unit placed in the scanning direction with respect to the rotation axis of the deflection member of the second ranging unit, and
the co-ranging state has a period equal to or smaller than a value obtained by dividing an angle between the emission azimuths of the first ranging unit and the second ranging unit at start of the co-ranging state by a difference between the ranging angular velocities of the second ranging unit and the first ranging unit in the co-ranging state.

11. The ranging device according to claim 1 wherein
the control unit controls the plurality of ranging units to cause the plurality of ranging units to change the rotating or oscillating angular velocities of the deflection members at different times.

12. The ranging device according to claim 1, wherein
the control unit controls the plurality of ranging units to cause periods of the deflection members having the highest rotating or oscillating angular velocities to have at least a non-overlapping time between the plurality of ranging units.
